(19) United States
(12) Patent Application Publication
(10) Pub. No.: US 2022/0001806 A1
(43) Pub. Date: Jan. 6, 2022

(54) Universal Mount System For Vehicle Roof Rack

(71) Applicant: Tiger Quach, Canyon Lake, CA (US)

(72) Inventor: Tiger Quach, Canyon Lake, CA (US)

(21) Appl. No.: 17/367,362

(22) Filed: Jul. 3, 2021

Related U.S. Application Data
(60) Provisional application No. 63/048,031, filed on Jul. 3, 2020.

(51) Int. Cl. B60R 9/04; B62D 65/16

(52) U.S. Cl. CPC B60R 9/04; B62D 65/16

(57) ABSTRACT

A Universal Rack Mounting System for vehicles to hold a roof rack attached to the outer body of a vehicle is provided. The Universal Rack Mounting System comprises a mounting block with sufficient flexibility to conform to the contour of a vehicle roof. The mounting block affixes to the ditch channel of a vehicle roof without the need to drill holes through the outer surface of the vehicle and can be used to attach a variety of commercial roof rack systems.

This claims the benefit of U.S. Provisional Patent Application No. 63/048,031 filed on Jul. 3, 2020, the entire content of the foregoing applications are incorporated by reference in their entirety.

### BACKGROUND

Vehicle roof racks typically have two or more cross bars which a variety of article carriers, such as winter and water sport racks, bicycle racks, and roof top cargo carriers, for example. Many trucks and sport utility vehicles (SUVs) SUVs have channels, also referred to herein as a roof ditch, which connect to mounting brackets which then affix to the roof rack cross bars. The mounting brackets for channel mounting systems, referred to herein as ditch mount systems, are permanently attached to the roof of the vehicle with the ditch mounting bracket. Ditch mounting brackets provide permanent fixed mounting points and are attached directly to the vehicle's naked roof with rivets or screws, requiring permanent holes be placed in the vehicle's roof.

Drilling of holes in the outer body of a vehicle is problematic in that drilling can produce sharp edges and fragments of metal which can come loose and potentially damage the headliner of the vehicle, thus necessitating expensive repairs. In addition, roof top holes in a vehicle leave an exposed metal surface which may rust or be otherwise corroded and water leakage through the holes into the interior area of the vehicle can occur damaging the headliner and interior of the vehicle. Also, fixed mounting brackets do not allow for repositioning of the rack or removal for resale.

Adaptors for attaching a roof rack system to a vehicle ditch without drilling are known. However, known adaptors suffer from one or more disadvantages of insecurely fitting to the ditch, causing instability in the roof rack, and/or a lack of adaptability to various roof curvatures for a universal fit to a variety of vehicles with different roof curvatures.

Therefore, there is a significant need for a way to attach a roof rack to a vehicle without drilling that is secure and adaptable to various car types. Preferably, the adaptor is movable and removable for repositioning and resale purposes and is low profile for aesthetic and aerodynamic purposes.

### SUMMARY

According to the present invention, a mounting block and system for affixing a vehicle roof rack to the surface of a ditch channel on a vehicle roof is provided. The mounting block comprises an elongated structure of unitary construction with a hollow interior. The hollow interior extending the width of the elongated structure and a substantial portion of the length, being bounded at opposite ends by end portions, a top portion and a bottom portion. A first elongated side has a first groove which extends along a bottom portion of the length of the first side. The first groove is configured to conform to the shape of a first side of the roof ditch channel. A second elongated side has a second groove which extends along a bottom portion of the length of the second side. The second groove is configured to conform to the shape of the second side of the roof ditch channel. One or more apertures are positioned on the top section of the mounting block to accept hardware for attaching a roof rack to the mounting block. According to other embodiments, mounting systems are described having four or more mounting blocks, and may include hardware for mounting a roof rack.

### BRIEF DESCRIPTION OF THE DRAWINGS

These and other features, aspects and advantages of the present invention will become better understood from the following description, appended claims, and accompanying figures where:

FIG. 1 is a top perspective view of a mounting block of the present invention, disposed within the roof ditch of the vehicle, according to one embodiment of the present invention;

FIG. 2A is a top view of the rack mounting system shown in FIG. 1;

FIG. 2B is a side view of the rack mounting system shown in FIG. 1;

FIG. 2C is a side view of the rack mounting system shown in FIG. 1;

FIG. 3A is a top view of the rack mounting system, according to another embodiment, showing the mounting block of FIG. 1, attaching to both a roof rack and a vehicle;

FIG. 3B is a side view of the rack mounting system and roof rack, affixed to a vehicle, as shown in FIG. 3A; and

FIG. 4 is a front side cut away view of the rack mounting system shown in FIG. 3A.

### DETAILED DESCRIPTION

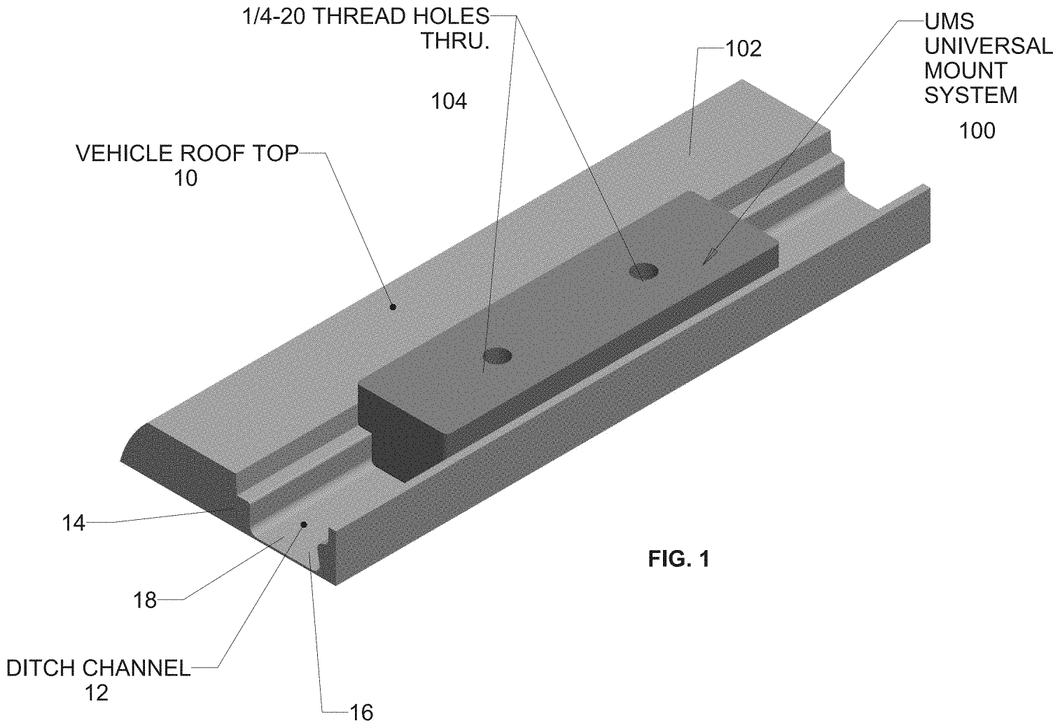

According to the present invention, a rack mounting system for affixing a vehicle roof rack to a vehicle roof ditch channel is provided. Referring now to FIG. 1, a top perspective view of a vehicle roof top 10 illustrating one embodiment of the rack mount system 100 of the present invention, disposed within the ditch channel 12, is shown. The universal rack mount system 100 comprises a mounting block 102 designed to fit within the ditch channel 12 of a vehicle roof top 10. The rack mount system 100 may vary in dimension and cross-sectional shape, depending on the dimensions of the ditch channel 12 to which it is fitted into. The rack mount system 100 is dimensioned such that sides of the mounting block 102 fit within and conform to the ditch channel 12 and is optionally flush with the vehicle roof top 10, the channel bottom 18 and channel sides 14, 16. In one embodiment, the rack mount system 100 is dimensioned such that it is concealed within the channel 12 and does not raise the overall profile of the vehicle roof top 10 once the mounting block 102 is fitted within the channel. The mounting block 102 has one or more apertures 104, such as threaded holes, to affix a vehicle roof rack thereto. Accordingly, the rack mount system 100 of the present invention attaches to a roof rack to a vehicle without drilling. The rack mount system 100 is secure and adaptable to various cars having different roof curvatures. The mounting block 102 may be removed and/or is movable and for repositioning on the vehicle or installing on another vehicle. In other embodiments, the mounting block is secured to the vehicle roof ditch channel with adhesive. In addition, the rack mount system 100 is low profile for aesthetic and aerodynamic purposes.

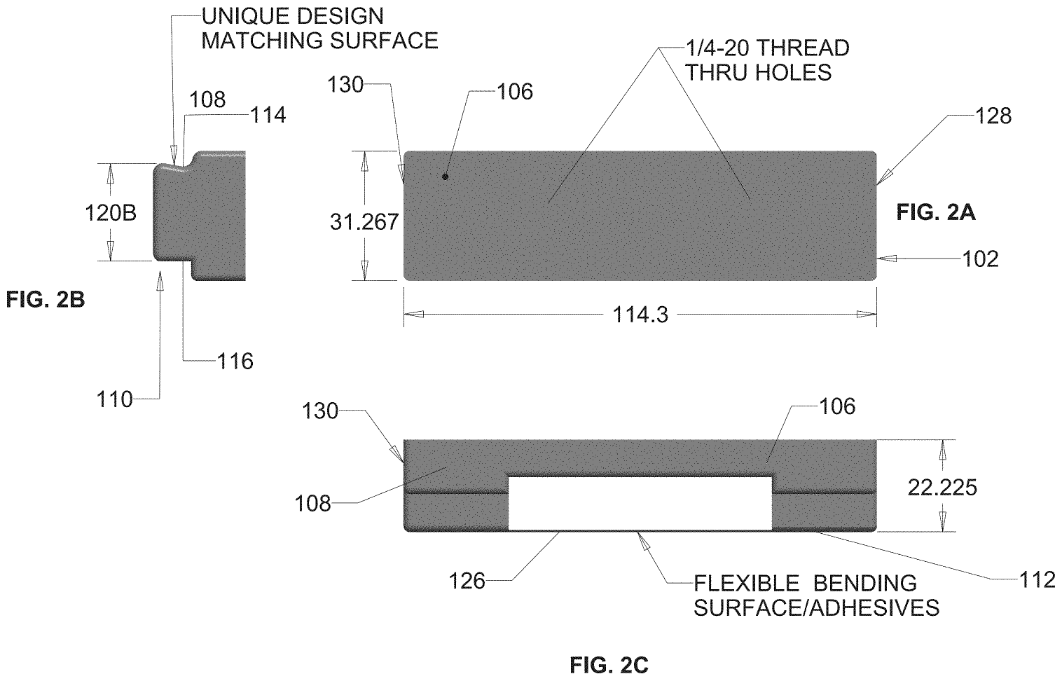

Referring now to FIGS. 2A, 2B, and 2C, top, end and side views of the mounting block 102 shown. The block 102 is preferably an elongated structure of unitary construction having a a length 118, width 120a and 120b, a depth (height) 122, a top section 106 with a top face, a bottom section 126 with a bottom face 128, and first and second end portions, 128, 130, an elongated rectangular shape with and elongated first side 108, and an elongated second side 110. The mounting block 102 has a first elongated side 108, which has a length 118 and a first groove 114 which extends along a bottom portion of the length of the first side 108, the first groove 114 is configured to conform to the shape to the channel first side 14 of the vehicle roof ditch channel 12. The mounting block 102 has a second elongated side 106, which has a length 118 and a second groove 116 which extends along a bottom portion of the length118 of the second side 110, the second groove 114 is configured to conform to the shape to the channel second side 16 of the vehicle roof ditch channel 12.

The top 106 of the mounting block 102 has one or more apertures 104 or pins. In some embodiments, the bores are threaded, or have an optional threaded insert (not shown). In one embodiment, the block 102 has two threaded bores 104 for mounting low profile roof racks, or other carriers and adaptors for mounting roof racks and article carriers of various known manufactured systems. Preferably, the height 122 of the mounting block is such that the upper face 106 is substantially flush with the roof 10 or substantially low profile when the mount 102 is secured within the ditch channel 12, as shown in FIG. 1.

The mounting block 102 has a hollow interior 124 with an open space spanning the width 120 and a substantial portion of the depth 122 of the mounting block 102 as shown in FIG. 2C. The hollow interior 124 terminates at opposite ends by the first and second end portions 128, 130. The thin bottom section 126 provides the mounting block 102 with flexibility. In some embodiments, the mounting block 102 can bend freely to conform to the contour of the outer surface ditch channel 12. As vehicles have various curvatures of the vehicle roof, the flexibility of the block allows for the same mounting block 102 to be used with any ditch channel having the same contour, regardless of the curvature of the channel 12. In some embodiments, the mounting block 102 has a dovetail design, the bottom width 120b being narrower than the top width 120a. The first groove 114 runs along the length 118 of the bottom portion of the side 112 of the block 102 and the second groove 116 runs along the length 118 of the bottom side 112 of the block 102 to affix to the outer surface of the ditch channel 12 which keeps the mounting block in place and avoids lifting and sliding. The outer surface of the vehicle ditch channel 12 has a taper at the start of the channel and at the end of the channel. The mounting block is slid into place in the ditch channel 12 until it is secured with a compression fit within the channel 12.

In some embodiments, a high temperature adhesive layer underneath the thin lower section 126 of the block 102 is provided. The adhesive may be provided as a double-sided adhesive strip or liquid adhesive applied to the mounting block 102 as a layer. A preferred adhesive has a temperature ranges from −35 degree to 300 degrees Fahrenheit which will keep the mounting block 102 in place once it is locked onto the outer surface channel. In other embodiments, a set screw can be used from a through hole in from the top of the mounting block and then be tightened to further secure the block 102 within the channel 12.

The mounting block 102 may be made from a wide variety of materials such as a polymeric material, metal, and/or wood, including but not limited to aluminum, steel, stainless steel, copper, brass, ABS plastic, polyethylene plastic, wood, and/or engineered wood. In a preferred embodiment, the block 102 is comprised of machined, cast or extruded aluminum. The mounting block 102 is shown herein with a unitary construction. However, it may comprise a multi-piece unit, such as the bottom 112 being of a different material, such as a flexible polymer and the top portion of the block 102 being constructed from metal and affixed to the bottom polymeric portion of the block.

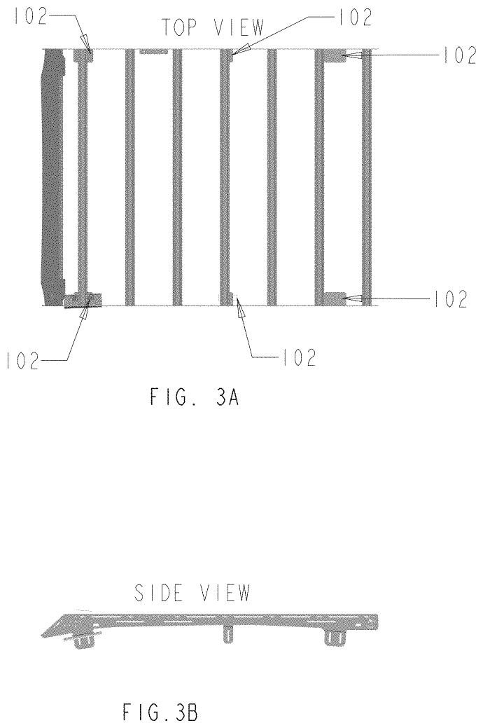

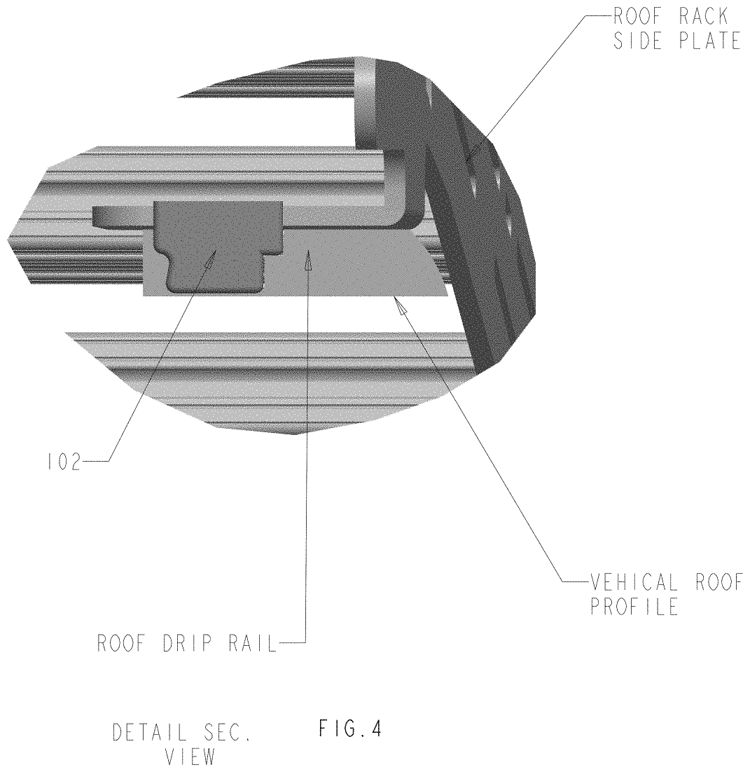

According to another embodiment, a mounting system comprising a set of mounting blocks and a roof rack system is provided, as shown in FIGS. 3A and 3B and 4. FIG. 3A is a top view of the rack mounting system, showing the mounting block of FIG. 1, attaching to both a roof rack and a vehicle. FIG. 3B is a side view of the rack mounting system and roof rack, affixed to a vehicle, as shown in FIG. 3A. FIG. 4 is a side cut away view of the rack mounting system shown in FIG. 3A. According to this embodiment, multiple mounting blocks 102 are used to directly secure a roof rack, or other article carriers to the vehicle. In the embodiment shown in FIG. 3A, four blocks 102, with two apertures 104 on each block 102, are mounted to a vehicle roof ditch channel. The rack is directly mounted to the four blocks 102 with mounting hardware. In one embodiment, the rack has four or more mounting points with two rack mount apertures each. The two apertures on the rack mounts correspond to the apertures (e.g., two threaded bores) 104 on each mounting block 102. The rack is affixed to the mounting blocks with bolts, rivets, or screws. For example, in a rack having six mounting points, 12 size 1/4-20 socket head cap screws may be used to affix the rack to six mounting blocks attached to a vehicle roof ditch. In one embodiment, an adhesive, such as a high strength epoxy, may be used for additional security. Although this embodiment is shown with a rack having four rack mounts, other embodiments are envisioned within the scope of the invention, such as the use of six mounting blocks 102 with a rack having six rack mounting points and six mounting apertures.

In other embodiments, cross bars of a roof rack system are directly mounted with a mounting block 102 on each side of the cross bar. In this embodiment, a set of 2 mounting blocks 102 is used for each cross bar of a roof rack, e.g., four mounting blocks for a two cross bar system, and six mounting blocks for a three cross bar system, affixed with screws or bolts as described herein above. Article carriers, such as winter and water sport racks, bicycle racks, and roof top cargo carriers are then attached to the cross bars as is known in the art.

According to another embodiment, a mounting system comprising a mounting block and top piece adaptor is provided. The top piece adaptor is a low-profile mounting adaptor having two or three apertures, configured to correspond to the pins on the mounting apparatus for the cross bars of a roof rack system, as is known to those of skill in the art. The mounting block has two bores which correspond to the bores 104 on the mounting block 102. The top piece adaptor is affixed to the mounting blocks 102 with bolts, rivets, or screws and the cross bars of a roof rack system having a mounting pin system are attached thereto. In other embodiments, the mounting block is a unitary construction having two or three or more pins which correspond to two and three pin mounting systems. In this embodiment, the top section of the mounting block rises above the ditch channel and the top face, having apertures (pins), faces toward the opposing mounting block to accommodate the cross bars of a roof rack system having a mounting pin system. This system is advantageous as it is low profile, removable, and allows for quick installation/removal of the cross bars.

According to another embodiment a vehicle roof rack mounting kit comprising four or more mounting blocks as described herein, mounting hardware, and instructions for securing the mounting blocks to a vehicle are provided. In another embodiment, instructions for securing the roof rack to the mounting blocks are provided.

According to another embodiment, a method of mounting a roof rack to a vehicle is provided. According to the method, a vehicle having two ditch channels positioned on opposing sides of the vehicle roof is provided. Four or more mounting blocks according to the invention are provided. The mounting blocks are positioned within the ditch channels and secured therein, with two or more mounting blocks on each of the opposing sides of the ditch channels. Then, a roof rack having apertures positioned to correspond to the apertures on the four or more positioned mounting blocks is provided. The roof rack is then affixed to the mounting blocks. Optionally, the mounting blocks may be secured within the ditch channels with an adhesive. The method is applicable to flush mount roof racks having two or more cross bars, or a roof rack of unitary construction to secure the flush mount roof racks to the mounting blocks. The method is also applicable to secure two or three pin system roof racks to the mounting blocks.

A principal advantage of the rack mount system 100 is that cross bars for a vehicle roof rack can be secured to the vehicle without the need for drilling any holes in the outer body surface thus eliminating water leakage through any such holes, creation of metal debris, and metal corrosion from drilling such holes. The rack mount system 100 is economical and adaptable to a wide variety of vehicles, and due to the flexible construction, the same mount can be used on different vehicles having the same channel structure with a secure fit. Using various top mounts, the mounting system can be used with rack systems from a variety of manufacturers.

Although the present invention has been discussed in considerable detail with reference to certain preferred embodiments, other embodiments are possible. Therefore, the scope of the appended claims should not be limited to the description of preferred embodiments contained herein.

What is claimed is:

1. A mounting block for affixing a vehicle roof rack to the surface of the ditch channel on a vehicle roof, the mounting block comprising:
an elongated structure of unitary construction having a width, a height, a top section with a top face, a bottom section with a bottom face, and first and second end portions;
a hollow interior, the hollow interior extending the width of the elongated structure and a substantial portion of the length, being bounded at opposite ends by the first and second end portions, the top section, and the bottom section;
a first elongated side, the elongated first side having a length and a first groove extending along a bottom portion of the length of the first side, the first groove configured to conform to the shape of a first side of the vehicle roof ditch channel;
a second elongated side, the elongated second side having a length and a second grove extending along a bottom portion of the length of the second side, the second groove configured to conform to the shape of a second side of the vehicle roof ditch channel;
one or more apertures positioned on the top section of the mounting block.

2. The mounting block according to claim 1, wherein the apertures are threaded bores.

3. The mounting block according to claim 1, wherein the top section and the top face are configured to accept a two or three pin roof rack system.

4. The mounting block according to claim 1, wherein the height of the mounting block is such that the top face is substantially flush with the roof of the vehicle, or the mounting block is substantially low profile such that the mounting block is secured within the ditch channel.

5. The mounting block according to claim 1, wherein the first elongated side and the second elongated side are configured to pressure fit within the ditch channel.

6. The mounting block according to claim 1, wherein the shape of the first groove and the shape of the second groove are different.

7. The mounting block according to claim 1, wherein the mounting block has sufficient flexibility to conform to the contour of a curved ditch channel on a vehicle.

8. A rack mounting system comprising four or more mounting blocks according to claim 1.

9. A rack mounting system comprising four or more mounting blocks according to claim 1, and a roof rack, and mounting hardware to affix the roof rack to the four or more mounting blocks.

10. A rack mounting system comprising four or more mounting blocks according to claim 1, wherein the top section and the top face of the mounting block are configured to accept a two or three pin roof rack system, and further comprising a two or three pin roof rack system.

11. A vehicle roof rack mounting kit comprising four or more mounting blocks according to claim 1; mounting hardware; and instructions for securing the mounting blocks to the vehicle.

12. A vehicle roof rack mounting kit according to claim 11 further comprising instructions for securing the roof rack to the mounting blocks, the mounting blocks being secured to the vehicle.

13. A method of mounting a roof rack to a vehicle comprising:
providing a vehicle having two ditch channels positioned on opposing sides of the vehicle roof;
providing four or more mounting blocks, each mounting block comprising:
an elongated structure of unitary construction having a width, a height, a top section with a top face, a bottom section with a bottom face, and first and second end portions;
a hollow interior, the hollow interior extending the width of the elongated structure and a substantial portion of the length, being bounded at opposite ends by the first and second end portions, on top by a center portion of the top section, and on bottom by a flexible center portion of the bottom section, the flexible center portion of the bottom section having sufficient flexibility to bend to conform to the contour of a curved surface of a ditch channel of a vehicle;
a first elongated side, the elongated first side having a length and a first groove extending along a bottom portion of the length of the first side, the first groove configured to conform to the shape of a first side of the vehicle roof ditch channel;
a second elongated side, the elongated second side having a length and a second grove extending along a bottom portion of the length of the second side, the second groove configured to conform to the shape of a second side of the vehicle roof ditch channel; and
one or more apertures positioned on the top section of the mounting block.
positioning the four or more of the mounting blocks within the ditch channels, with two or more mounting blocks on each of the opposing sides of the ditch channels;
providing a roof rack having apertures positioned to correspond to the apertures on the four or more positioned mounting blocks; and
affixing the roof rack to the mounting blocks.

14. The method of mounting a roof rack to a vehicle according to claim 13, further comprising securing the mounting blocks within the ditch channels with an adhesive.
